(19) United States
(12) Patent Application Publication
(10) Pub. No.: US 2011/0258125 A1
(43) Pub. Date: Oct. 20, 2011

(54) Collaborative Social Event Planning and Execution

(76) Inventor: Vinay Rama Iyer, Oakland, CA (US)

(21) Appl. No.: 13/086,393

(22) Filed: Apr. 14, 2011

Related U.S. Application Data
(60) Provisional application No. 61/324,752, filed on Apr. 16, 2010.

(51) Int. Cl. G06Q 10/00

(52) U.S. Cl. 705/301; 705/14.5

(57) ABSTRACT

Collaborative social event planning and execution is disclosed. The embodiments herein relate to event planning and, more particularly, to collaborative event planning. In existing event planning schemes do not satisfy the requirements of users as there are no means to personalize the planning to suite the requirements of the user. They have a predefined template for each event and anything other than the template cannot be implemented. The collaborative social event planning mechanism provides a mechanism wherein users may plan any kind of event as per his choice. The method allows flexible planning environment to create event plans, create templates to suit user's requirement and also share it with others. The content and templates are community generated. Also, allows for multi-device mobile access. There is dynamic collaboration among event managers and collaborator teams. In addition, the method provides a unique monetization model and facilitates sponsors, advertisers to display their content.

This application claims the benefit of U.S. patent application Ser. No. 61/324,752, filed Apr. 16, 2010.

### TECHNICAL FIELD

The embodiments herein relate to event planning and execution and, more particularly, to social collaborative event planning and execution.

### BACKGROUND

Social events such as birthdays, weddings, business conferences are an important part of social life. Any kind of event requires planning, preparation and execution. And, if an event is a little complex in having more than a few activities that need to be planned and executed, the responsibilities are usually shared by a team of people. For example, in a birthday party event, someone takes responsibility for finding a location, someone for ordering a birthday cake, someone else for ordering food, etc. If it is a business conference, different people are responsible for managing the location, recruiting and scheduling speakers, planning, hosting a reception, etc.

Typically, there is an overall owner (for example, host, assigned leader, professional manager and so on) for an event who is responsible for successful execution of the event. The owner recruits a team of people to help, plan and execute the event.

For most events, planning starts several weeks, if not months prior to the date of the event. The event team frequently meets and collaborates during this time period to ensure proper planning and execution. Event planning typically involves identifying appropriate activities and sub-activities that would be relevant to the occasion, identifying overall budget availability, assigning budgets and responsible team members per activity, establishing time lines for execution, and reporting and status tracking to make sure everything gets done right within established time lines and budgets. During the course of planning and execution, there often is frequent communication among the event team members. Upon successful completion of an event, there often are some follow-up activities like sending out thank-you notes and pictures before an event is considered successfully executed and completed.

Any event can be split into three logical parts, namely planning, collaboration, and execution. Planning an event is often done either by prior experience the event owner has, by recommendations from friends and family, or, sometimes, by recommendations from vendors or professional event planners. The event owner also owns the budget for the event, and tries to maximize event activities to get maximum benefit for the available budget.

Collaboration among the event team today most frequently occurs through telephone calls, emails, physical meetings, spreadsheets, paper notes, etc. The team frequently gets together, discusses the event and the plan, and settles on a course of action. Budgets and ownership are also assigned, along with time lines for execution based on past experience, or certain assumptions. The event owner captures all this information on a piece of paper, or in an email or in a spreadsheet and shares this with the team members so that everyone is informed, and can plan and execute their activities accordingly. The event plan itself is also, often, captured on paper, spreadsheet or email by the event owner, and shared with the team members.

Execution of the plan for an event is done by the members of the team. The team frequently meets via telephone or physical meetings, and also exchanges information by email, to give updates, track exceptions, identify/resolve any problems, and plan next steps. The event owner periodically updates the event plan statuses, and redistributes it to the team members. Often, the event owner has to frequently remind the team to perform the tasks, give updates to their activities, and provide any escalations needed.

The practices of planning and organizing events that are common today lend themselves certain limitations and inefficiencies. As noted earlier, most often, events are driven by few key people that have had experiences in planning and organizing similar events. It means that current common practice does not allow for learning from broader community experience available for event planners. Further, more often, collaboration is off-line and inefficient. If some individuals cannot attend planned meetings, the entire team suffers from not having updates and latest statuses of various activities. Furthermore, entire plan is managed and coordinated by one or few ‘owners’. These owners often spend a lot of time coordinating with the team to ensure planned activities are carried out according to the plan, and, more often, results in a stressful experience for the entire team in executing the event plan. Still further, any changes to plans or activities need to be manually communicated by the owner to all team members and vice versa, and may result in sub-optimal execution due to communication gaps. And, enormous amount of time may be wasted in sharing, reporting, tracking, managing, meetings, etc. Also, tracking actual cost and comparing such costs against budget allocations requires manual calculations and can become complicated.

There are software solutions available, that may offset some of the disadvantages associated with planning and executing an event manually through traditional mechanisms. Software solutions fall into two broad categories, namely client-based software, and client-server based software.

Several vendors offer software solutions to help event owners/managers plan, execute and track events. These solutions require purchase of software packages and installation of software on local computers. The primary audience for these software packages is the event owners and not the event team. And, therefore, there is no concept of collaborative planning and execution by a team of people. Further, client-based software solutions are inherently painful because of the way they are licensed, installed, networked, maintained, upgraded, etc. Even if a collaborative software were available, each event team member would have to purchase a license for the software, install it on their individual computers, somehow establish a computer network (e.g. a LAN), and collaborate. Every time a new team member is added, they have to also license the software, install it, become part of the network, etc. Further, each user has to ensure they are on the same version of software for true collaboration to flow smoothly. In general, client-based software has not proven successful for collaboration and that software model has been replaced by Internet-based software applications.

With the growing popularity of the Internet, a number of applications have sprung up in the recent past to help with event planning. However, the approach taken by Internet-based software vendors has mostly been to provide an application to manage a specific type of event. For example, a particular Internet event planning service will provide services specific to say, a Christian church-based wedding. Such services allow for planning events of a particular type following a predefined format. Users will not have the flexibility to modify the format according to their specific requirements. Such users will have to find another Internet based service all together. For example, if another user wants to plan a Hindu-style wedding, they will have to use the services provided by another website. For aforementioned reasons, an end-user cannot plan just any type of event flexibly on any available website. Further, existing websites cater to the needs of event owners/managers, and not to the entire team that is involved in planning and executing an event. Furthermore, existing websites have been designed by the website owners to solve one or few specific problems based on the expertise of the website owner and not on the collective expertise of the community of users. Such systems attract limited number of users and, consequently, make for a weak business model to attract advertisers.

### BRIEF DESCRIPTION OF THE FIGURES

The embodiments herein will be better understood from the following detailed description with reference to the drawings, in which:

FIG. 1 illustrates the architecture of the network involved in collaborative event planning, according to embodiments as disclosed herein;

FIG. 2 illustrates different modules of the event planer, according to embodiments as disclosed herein;

FIG. 3 is a snap shot indicating event planning platform for an event, according to embodiments as disclosed herein;

FIG. 4 is a snap shot depicting header information for each EAM, according to embodiments as disclosed herein;

FIG. 5 illustrates activity planning and tracking for each EAM, according to embodiments as disclosed herein;

FIG. 6 is graphical representation of activities for each EAM, according to embodiments as disclosed herein;

FIG. 7 is a snap shot indicating a community based template for EAM, according to embodiments as disclosed herein;

FIG. 8 is a snap shot indicating a sponsored template for EAM, according to embodiments as disclosed herein;

FIG. 9 illustrates sequencing of EAMs, according to embodiments as disclosed herein;

FIG. 10 indicates configuration of sub objects with EAM, according to embodiments as disclosed herein;

FIG. 11 is a flow chart illustrating template creation for an event, according to embodiments as disclosed herein;

FIG. 12 is a flow chart illustrating mobile collaboration, according to embodiments as disclosed herein;

FIG. 13 is a flow chart depicting contextual placement of ads, according to embodiments as disclosed herein;

FIG. 14 is a flow chart depicting the process of tracking and managing events, according to embodiments as disclosed herein;

FIG. 15 is a flow chart depicting the process of managing event calendars and schedules, according to embodiments as disclosed herein;

FIG. 16 is a flow chart depicting the process of managing calendar events and scheduling, according to embodiments as disclosed herein;

FIG. 17 is a flow chart depicting a process for controlling access for user, according to embodiments as disclosed herein;

FIG. 18 is a flow chart depicting the process of monetization, according to embodiments as disclosed herein; and

FIG. 19 is a flow chart depicting revenue based monetization, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

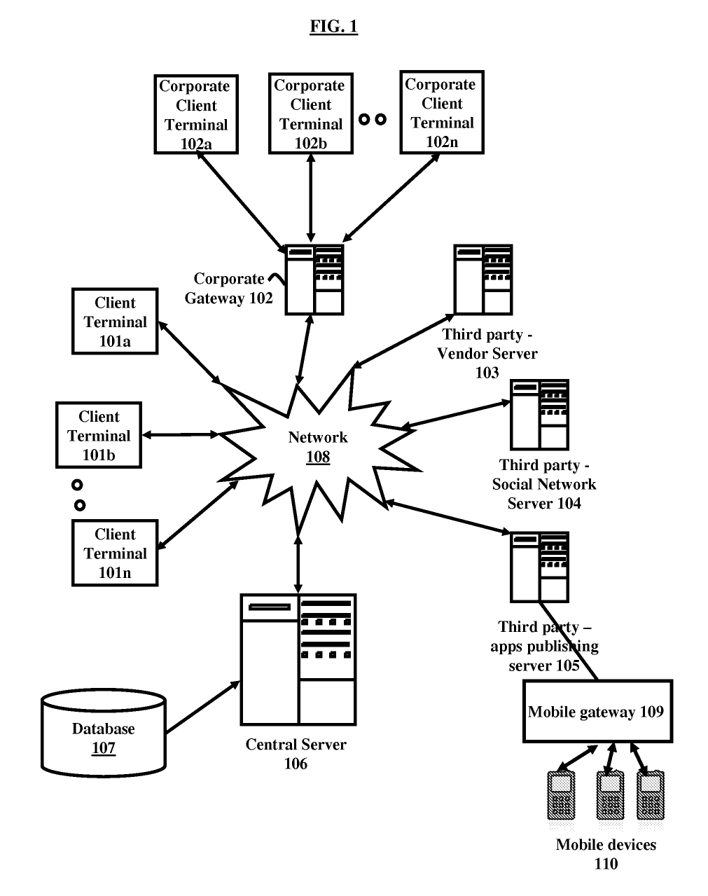

The embodiments herein disclose a mechanism for collaborative social event planning and execution by providing systems and methods thereof. Referring now to the drawings, and more particularly to FIGS. 1 through 19, where similar reference characters denote corresponding features consistently throughout the figures, there are shown embodiments.

FIG. 1 illustrates the architecture of the system involved in collaborative event planning, according to embodiments as disclosed herein. The system comprises of a plurality of client terminals 101a, 101b . . . 101n; a corporate gateway 102 that further comprises of different corporate client terminals 102a, 102b . . . 102n; a third party vendor server 103, third party social network server 104, third party application publishing server 105, a central server 106, a database 107, a network 108 and a mobile gateway 109 that connects to several mobile devices 110.

The client terminal 101a, 101b . . . 101n includes a plurality of terminals that enable a client to interact with the event activity modules (EAM) and the network 108. A client interacts with the network 108 through the client terminal 101. Any requests from the client are accepted by the client terminal 101. Further, the requests may be routed to a central server 106 through a network 108. The central server 106 analyzes the request and routes the request to the appropriate destination in order to extract the required information.

The corporate gateway 102 acts as an intermediary between the client terminal 101 and the corporate client terminal 102a, 102b . . . 102n. When the client requests for some details of his choice, the request may be routed to the corporate gateway 102. Further, the corporate gateway 102 determines the exact corporate client terminal 102a, 102b . . . 102n to be contacted and contacts the corporate client terminal 102a, 102b . . . 102n. The corporate client terminal 102a, 102b . . . 102n stores information regarding licensing requirements of different companies for use of the application by multiple departments, geographies and the like. Information on rights of authorization of different levels of users, administration of the rights, number of users of the rights, the contract companies signed up for the rights and so on are maintained at the corporate client terminal 102.

The third party vendor server 103 includes information on other third party services. The third part services may include some value added services such as travel, lodging and websites like Travelocity, Expedia, Kayak, etc. In addition, information on advertisers, sponsors and professional planers and other vendors may also be available. The third party vendor server 102 may also include information on request from different vendors for bids, event plans and the like.

The third party social network server 104 includes applications supporting interaction with different social communities such as Facebook, MySpace and the like. The native capabilities of these common social communities will be leveraged to extend the functionality of event activity module. In addition, to leverage the powerful multi-media collaboration features of Google Wave and other similar collaboration tools in the context of event planning collaboration, application supporting integration will be provided between the solution and Google Wave in the third party social network server 104.

The third party apps publishing server 105 enables interaction with the third party services such as mobile applications, web based applications and the like. The third party apps publishing server 105 enables interactions with different vendors, collaborators, sponsors etc via mobile applications using the mobile gateway 109. The applications will be delivered for common smart phones such as iPhone, Blackberry, Nokia (Symbian), Microsoft Windows Mobile devices, Android, iPad, etc. The mobile apps will be synchronized seamlessly with the Internet-based solution. Users can both access relevant information securely through mobile phones 110, as well as input information on the mobile phone 110 and update the solution.

The central server 106 is responsible for processing every action to be performed. All the requests are routed to the central server 106, which then determines the exact destination to which the request is to be routed. The database 107 acts as a repository for storage of information. All the data related to the event planning, that is to be saved, may be stored in the database 107. The database 107 stores the templates saved by the users, and enables access to the information when requested. The network 108 acts as a medium for interaction between the different modules of the event planner. The network 108 routes the request from the source to the appropriate destination. The mobile gateway 109 enables interaction between the mobile device users and the third part server 105. Any information may be sent to the mobile devices 110 through the mobile gateway 109.

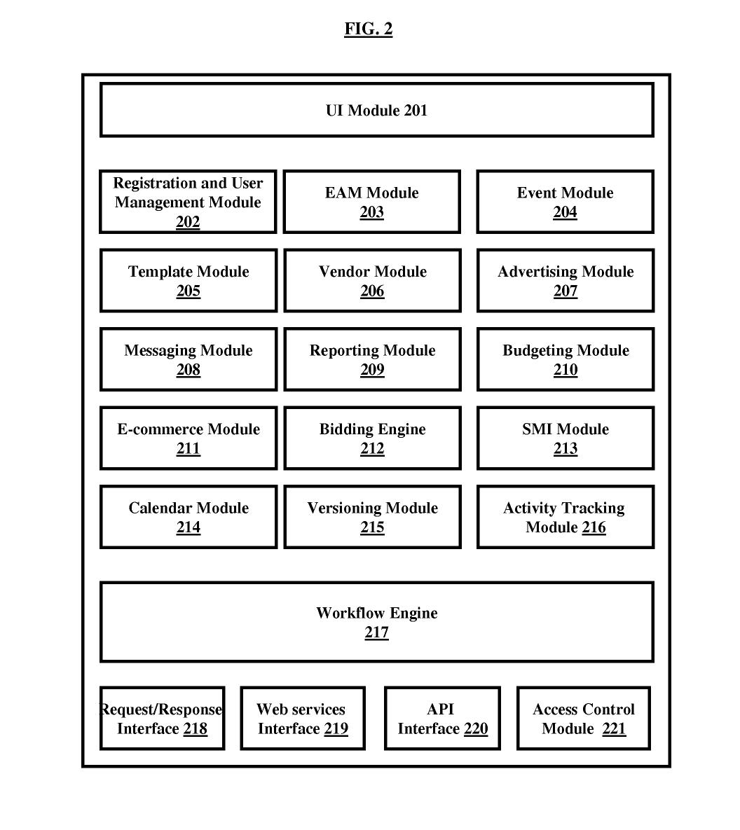

FIG. 2 illustrates different modules of the event planer, according to embodiments as disclosed herein. The event planner comprises of different modules that handle different functionalities of the event planner. The modules function in sync, in order to manage the services provided to the users. The UI module 201 is provided with interactive application, in order to enable easy user interaction. The application may provide intuitive, graphical based user interface to make it easy for the users to interact. The event planning solution may comprise of drag and drop user interface for the event planner application. The interface provided to the user may comprise a design ‘pad’ where the user can flexibly drop modules from the design palette, configure the desired event, establish links and hierarchies. In addition, a design palette, which contains the different EAMs for the user to select is also provided. The user can select any type and any number of EAMs from the palette, and drag-and-drop them into the design pad. The interface also provides the feature to click on icons like ‘+’ and ‘A’ on the EAMs and launch the associated windows for data entry.

The registration and user management module 202 maintains information on users who register for the event planning service. Every user who desires to use the event planner service may be required to register for the service, on a web site provided. On registration, the user may be authenticated. The registration and user management module 202 may maintain details of users, such as, the type of event plan the user is looking for, identification number provided to the user and the like. This information may be employed in future for any reference. The registration and user management module 202 also manages different users by categorizing the users according to their requirements. This type of categorization may help in easy access of information of the user every time he logs in to access the service.

The Event activity module (EAM) module 203 is responsible for maintaining details of different EAMs available for an event. In an example, for an event such as a party, the EAMs available in the design palette may be location, food, entertainment, clean-up, transport, invites, thank you notes and the like. The EAM module 203 will organize the available EAMs and provide the list of the EAMs to the user, based on the event plan entered by him. EAMs displayed in the design palette for selection may vary based on the event entered by the user.

The event module 204 is responsible for the overall management of the entire event information entered by the user. The event module 204 performs regular checks on the updates, cancellations and changes made in an active event. All the event updates may be sent as and when required by the event module 204.

The template module 205 maintains a list of pre-defined templates for some standard events that may be accessed by the user if desired. The template modules 205 also allow a user to modify a particular template chosen from the template module 205. Each EAM can contain a number of different activities for execution. These activities may be pre-populated as activity templates and stored in the template module 205. In addition, any saved event plan may be published by clicking on the publish button. The published event plan may be stored as a template in the template module 205.

The vendor module 206 handles interaction with the vendors. The vendor module 206 maintains details on bids from different vendors, vendor's recommendations and the like. Vendor module 206 also enables a user to connect to a particular vendor's web site that may be of interest to him. The vendor module 206 ensures privacy to the information of vendors such as bids offered by the vendor and so on.

The advertising module 207 provides information of advertisers, sponsors etc who may be interested in advertising their ads for a particular event. Contextual advertisers, who opt to display their sponsored ads, banner ads and the like, may be allowed to do so by charging for the same. An advertiser, who may be interested, may register with the event planning service and details of his ad may be maintained in the advertising module 207.

The messaging module 208 is responsible for handling workflows, notification etc for an on going event to alert users of critical statuses and follow-up actions required. For any event, that may be active, updates on the activities in progress in relation to the event may be sent to collaborates and the event organizer by the messaging module 208. The messaging module 208 may intimate the people involved in an event regarding the progress of the event by sending a message notification or the like. The event planner may capture the contact information (email address, mobile phone number, etc.) for all collaborators. It may be required to get explicit permission from the collaborators to receive notifications such as emails and SMS messages. The messaging module 208 will provide functionality to manage these permissions.

The reporting module 209 provides summarized information to all users with broad set of reporting capabilities. Some key reports provided may be: 1. Event plan summary—helps event planners obtain a comprehensive report of the entire event plan showing information such as EAMs and owners, deadlines/due dates, budget, etc. 2. Budget summary—breakdown of overall budget by spend items and owners. 3. Actual vs. budget—summary of actual vs. budget broken down by each spent item. 4. My Activities—summary of all activities (across multiple active event plans) for each user.

The budgeting module 210 maintains cost related information of the EAMs of an event. Since each event plan and most EAMs associated with an event plan will incur a cost, functionality is provided to establish a budget and also track actual costs at the EAM level, as well as, at the higher Event Plan level. All budget amounts, as well as actual costs incurred, will be manually input by the user. All totals will flow upward so that a summary of budgets and actual can be obtained at each higher node level. The budgeting module 210 may send a RED alert for each item, if actual cost set by the user exceeds the budgeted cost.

To enable plan execution directly from the event plan, an E-commerce module 211 will be provided. The E-commerce module 211 manages the transactions to be executed with vendors. Users can access vendor websites and catalogs from the e-commerce module 211. Users can select items to purchase on the vendor sites and execute an ecommerce transaction on the vendor's site. A record of the ecommerce transaction will be maintained in the e-commerce module 211 for future reference and tracking of actual costs.

The bidding engine 212 handles solicit bids from vendors based on the type of event planned, location, budget, activities, etc. Most events have a budget constraint and it is the intent of every event planner to maximize what they can get from the various vendors for a given budget. The bidding engine 212 provides a mechanism for event planners to publish their event plans and request for bids from participating vendors. Vendors can then respond to request for bids and the event planner can select the best vendor offer. Vendors will have a secure website to login and see new requests for bids. An email will also be sent to the participating vendors with the details of bid request. Vendors can respond to the bid requests, through the secure website and vendors will be offered privacy by the bidding engine 212 so that they cannot see competing vendors' bids.

The Social Media Integration (SMI) module 213 acts an interface to media platform. The SMI module 213 provides logic to integrate with different social networking sites and media applications such as Facebook, MySpace, LinkedIn and the like.

The calendar module 214 enables integration and synchronization of the activities with calendaring software like MS Outlook calendar and the like. The calendar module 214 may provide a calendar to easily summarize the set of EAMs and activities for a given event plan. The calendar module 214 may provide a summary at the EAM level. Further, drill down may show details of activities (only those activities with start dates will be shown). In addition, color code may be used to show completed, pending and delayed EAMs and activities. Daily, Weekly and Monthly views may also be offered by the calendar module 214.

The versioning module 215 provides versioning capability to event plans. Versioning capability will be provided for event plans to help users keep track of plan changes and edits. Versioning is enabled automatically, when a user creates a copy of an existing plan and saves it under the same name. A new version number is automatically added if the user saves a copy of an existing plan under a different name, the saved plan is defaulted to the starting version number ‘1’. Any functionality related to versioning may be handled by the versioning module 215.

Activity tracking module 216 is responsible for tracking the progress of an active activity. The module 216 records any changes or updates in the activity, and intimates the users and collaborators. Each EAM may contain a number of different activities for execution. These activities may be pre-populated (as activity templates) or added by the user. Activities can be accessed by clicking on the ‘A’ icon in the EAM. Clicking on the ‘A’ icon launches the activity window. The activity tracking module 216 may maintain a table in order to track the progress of the activity. The table may maintain a unique id for every activity, a created by field to indicate the person who created the activity. A description for the activity, number of persons involved in the activity, start date and end date, status of the activity, notes field, add and delete options for the activity, ability to filter the table and search for required fields by columns and the like.

The workflow engine 217 handles the workflow among different modules. The workflow engine 217 acts as a central node and manages the flow of control towards different modules. The workflow engine 217 helps the planner and the EAM owner execute the set of activities associated with it. When an event plan is active, the solution will use pre-built workflows to alert both event planner(s) and collaborators about pending start-dates, due-dates, activities past due, and completed activities. The workflow engine 217 mainly provides alerts to users of critical statuses and follow-up actions required.

The request response interface 218 handles requests obtained from users or collaborators and routes the request to the appropriate module. Further, the required response to the request is also extracted from the modules and sent across to the users.

The web service interface 219 handles interactions of the users with different web services. In an example, when a user would want to visit a particular bidder's web site, the web service interface enables connection of the user to the required web site. The API interface 220 handles interactions with different applications. The applications may be internal applications or some other web based applications.

In an embodiment, collaboration of different members for handling different activities of the EAM is possible. In such case, all members of the event team can access and share information and status with others in the team. Each user will have their ‘window’ into the overall event plan so that they can fully execute those aspects of the plan they are responsible for. An event can have multiple collaborators with EAM owned by one or more collaborators. EAM owners are assigned by the event planner.

When a collaborator logs into the system, they will have full access to those EAMs and activities they are owners of, so that they can execute those functions. Collaborators will have read-only access to EAMs and activities of which they are not owners. An add on module called Access Control Module 221 is provided. The event manager will be able to control access (read, write, no access) to different EAMs and users (collaborators.) Based on the usage scenario, collaborators may be given more or less access to the overall event plan. Casual collaborators may only be given limited access to a few EAMs while others may be given full read/write access. This will help control the security of information access so that the integrity of the overall plan can be tightly controlled where required.

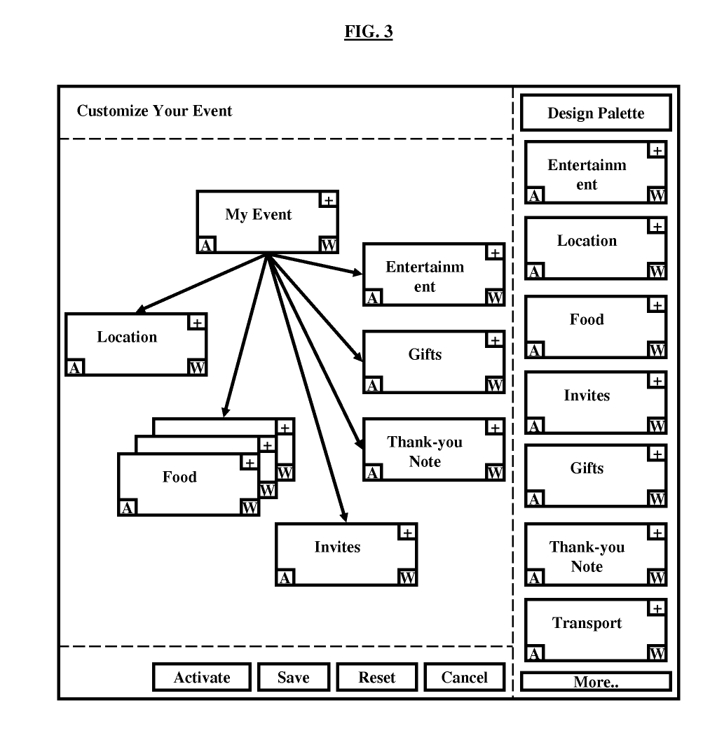

FIG. 3 is a snap shot indicating event planning platform for an event, according to embodiments as disclosed herein. Consider a user is interested in planning an event such as a party. The user logs in to the event planning environment. On logging in, the user may be required to make a registration for the event planning service. On registration, the user may be provided with a login id and password for accessing the event planning service. In an embodiment, user may be required to provide some details like his full name, id, mode of payment chosen by him and the related. Further, the user may enter the event he wishes to plan for. On entering the event, the user may choose to either select an event plan from the available templates or he may want to create a plan of his own. The user may go to customize your event option provided in the web site. In the following example, as the event chosen by the user is a party, he may name the event as ‘My event’. On entering the event, the user (person planning the event) may be provided the design palette. The design palette may comprise of a list of EAMs for the event. The person planning the event can select any type and number of event plan modules (EAM) from a design palette and include it as part of his event plan. Each EAM contains relevant Header Information to help the planner plan a set of activities associated with it. Each EAM also contains a set of business logic and workflow to help the planner and the EAM owner execute the set of activities associated with it. The user may choose a list of EAMs such as location, food, invites, thank-you notes, gifts and entertainment. Further, the user may choose to either save the created event plan as a template or he may just activate the event with the list of activities to be performed. Once the event is activated, the progress of the event may be tracked by the activity tracking module 216. The event planner may assign different activities of the event to different persons. For example, food may be assigned to someone; entertainment may be assigned to another. Each EAM may be provided with a header. The user may also choose to reset the entries entered by him by selecting the reset option or may want to cancel the entire event by clicking on the cancel.

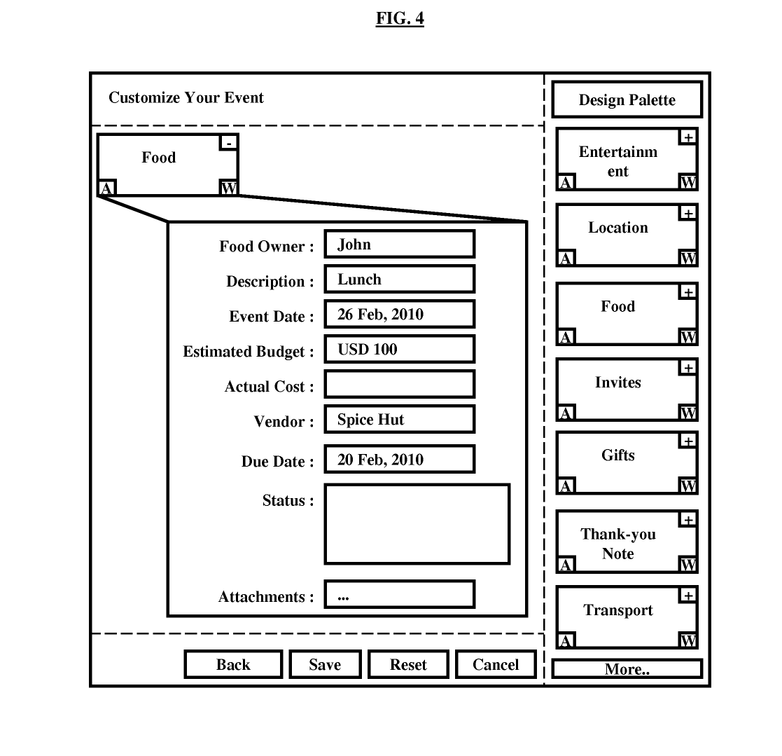

FIG. 4 is a snap shot depicting header information for each EAM, according to embodiments as disclosed herein. For an event entered by the user, he may either choose few EAMs from the design palette or may wish to add some additional EAMs. Each EAM for any activity may comprise of a header and information related to that activity. Each EAM contains a core set of information that needs to be captured to help both the event planner and the EAM owner understand the details of what is required for executing that module. Header information can be accessed by clicking on the ‘+’ icon, as shown in the FIG. 4. Header information can be specific to a given EAM. In an example, for the EAM provided in FIG. 4 i.e., for food the fields required may be ‘food owner’ wherein the name of the owner is provided, ‘description’ that indicates if it is lunch, dinner or break fast. Other fields include event date, estimated budget, actual cost, vendor, due date, status and attachments. The number and type of fields available may vary with the type of EAM entered by the user. Some of the field information may be automatically inherited from an upper node (e.g., owner information or event date would be defaulted to the same information as the higher-level node.) Other information would have to be manually input by the user (event planner or EAM owner). Some information would be editable only by the event planner and read-only for others (e.g., event date). Some information can be edited by either the event planner or the EAM owner (e.g., notes). Some fields may be compulsory (shown with a ‘*’) while others may be optional. Further, the created event plans may be saved by clicking on the save option provided. Each event plan will have a unique Event Plan ID automatically assigned by the system. Multiple versions of a plan can be saved by the user. Each saved plan will have a unique name assigned by the user. Upon saving a plan, the system will automatically assign a time and date at which the plan was saved. The event plan may also be reset using the reset button. The RESET button will default the data to what was defined in a saved template or a previously saved event plan. If the user wants to cancel recent changes to the plan, he can CANCEL without saving. All edits made to the plan will be lost. The user will be presented a pop-up window asking for confirmation before the CANCEL is executed. This is to prevent unintended data loss. Once the event is planned and all required information is input, the Event Planner can activate the plan to enable execution of notifications and workflows. The ACTIVATE button will be active only when all required data fields are input with valid information. If the Event Planner wants to deactivate the event plan for whatever reason (such as for cancelling an event), clicking on the DEACTIVATE button will stop all workflows and notifications. The DEACTIVATE button will be active only when the event plan is active. The DEACTIVIATE button is only available for the Event Planner. Other collaborators will not be able to see the DEACTIVATE button.

In an embodiment, pre-built workflows may be used in order to alert both event planner and collaborators about pending start-dates, due-dates, activities past due and completed activities of an event plan that is activated. Notifications will be sent as emails to the planners and collaborators for the relevant activities and EAMs. The email and other contact information for all users will be captured separately in the system. This information can be manually imported by the Event Planner, or input by the collaborators. Notifications will also be indicated in the solution itself with a color code once the event plan is active. Color code will be available for EAMs as well as activities. Green color indicates activity on track status. The activity is not past due and the status is ‘In Progress’. Yellow color indicates activity not on track status i.e., activity is not past due but the status is ‘Not Started’ or ‘On Hold’ or ‘Delayed’. Red color indicates activity is delayed status. The activity is past due and the status can be anything.

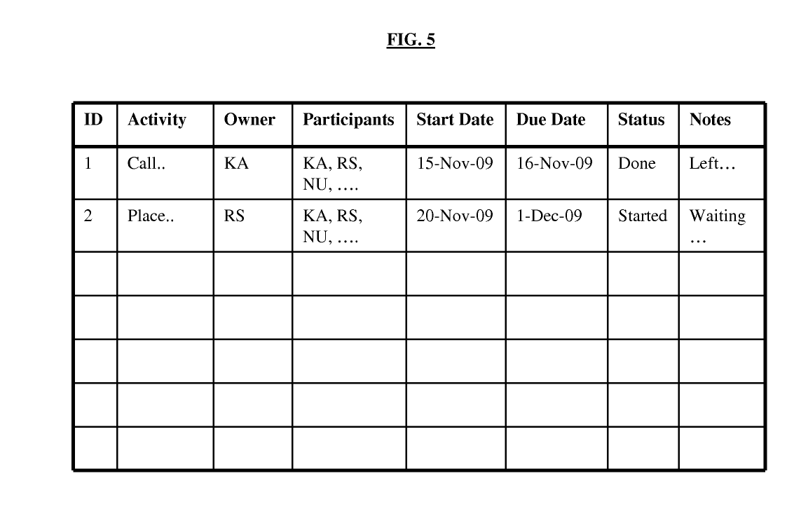

FIG. 5 illustrates activity planning and tracking for each EAM, according to embodiments as disclosed herein. Each EAM can contain a number of different activities for execution. These activities may be pre-populated (as activity templates) or added by the user. Activities can be accessed by clicking on the ‘A’ icon in the EAM. Clicking on the ‘A’ icon launches the activity window. In the example, for the EAM food, the list of activities may be call restaurants to enquire delivery options, place order for food, and ask for payment options and so on. In an embodiment, every activity may have a unique id generated by the system to track the activity, name of activity, owner that may be EAM owner by default but may be assigned to any other owner as well, participants, and start date, due date, status that may be updated by the owner, and notes to be entered. For the activity ‘call restaurants to enquire delivery options, the activity id is ‘1’, owner name is ‘KS’, participants who may be involved in carrying out the activity are ‘KS, RS, NU’; start date is 15 Nov. 2009; status is ‘done’; and notes is ‘left’ indicating that the activity is left to the assigned person and will call later and inquire about the activity. The notes field is for reference of the user who has created the activity and he may add details for his understanding to track the progress of the activity. On similar lines every activity may be provided with the described fields. In another embodiment, the table may also comprise of additional fields such as ‘status date field’ which may be a read only field and the field may be updated automatically once the status is updated by the owner. In addition, there may be ability to filter the table by column, ability to search for activities in the table column wise and to integrate/synchronize activities with calendaring software such as Microsoft outlook and the like.

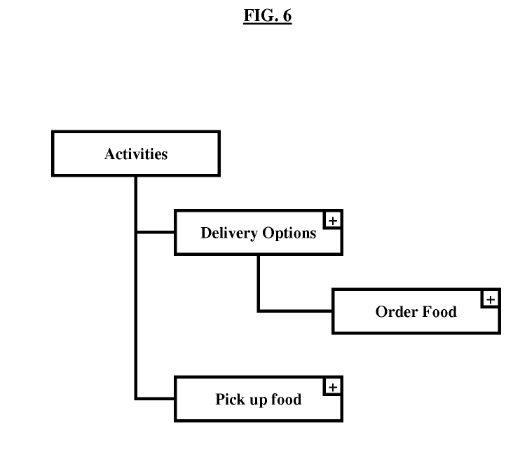

FIG. 6 is graphical representation of activities for each EAM, according to embodiments as disclosed herein. Each EAM can contain a number of different activities for execution. These activities may be pre-populated (as activity templates) or added by the user. Activities can be accessed by clicking on the ‘A’ icon in the EAM. Clicking on the ‘A’ icon launches the activity window. The list of activities maintained in the activity tracking module 216 may be made dependent on each other. In the example, for the EAM ‘food’ activities such as call restaurants to enquire delivery options, place order for food, and pick up food may be made dependent on one another. The activities may organized such that activity A i.e., call restaurant may be performed first. On completion of activity A, activity B and C which are place order for food and pick up food may be performed respectively.

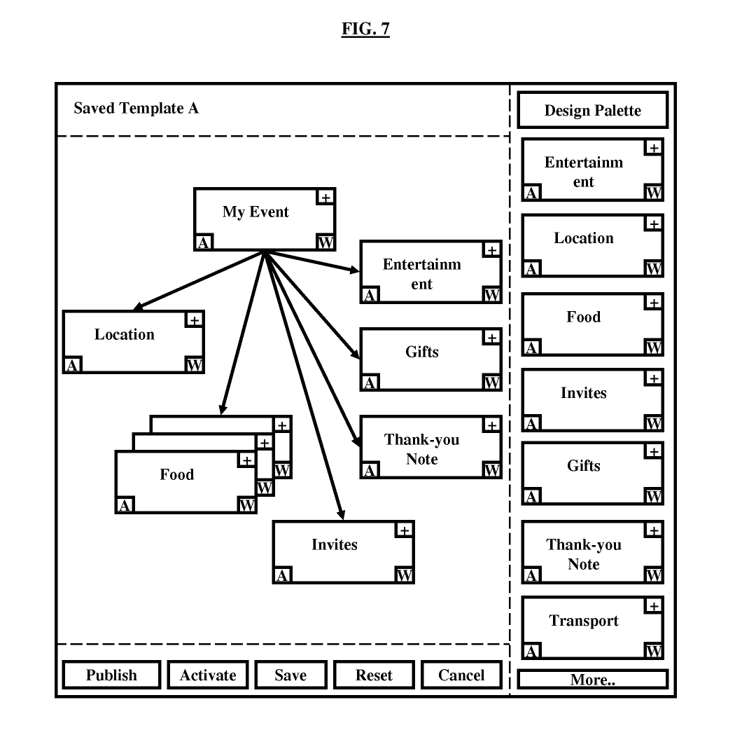

FIG. 7 is a snap shot indicating a community based template for EAM, according to embodiments as disclosed herein. The flexibility offered to custom plan any event to anyone's liking, the community driven content may be added by enabling event planners publish any of their events as templates. Any saved event plan can be published as a template by clicking on the ‘PUBLISH TEMPLATE’ button. An option will be provided to publish the template to the entire user community as PUBLIC or only to the community of contacts of the user as PRIVATE. For the template to be published, only certain data fields will be retained in the published template. Proprietary information such as owner information, activity participants, etc. will not be copied over in order to protect user confidentiality. In addition, it is also possible to tag the templates for enabling easy searching both within the solution as well as from external search engines like Google, Yahoo, Bing, etc. Templates may also be rated by users or collaborators who access the templates. Users who access templates can rate them (standard 5-star rating). Users who access templates can comment on them based on their experience either hosting the event or attending an event based on the published template.

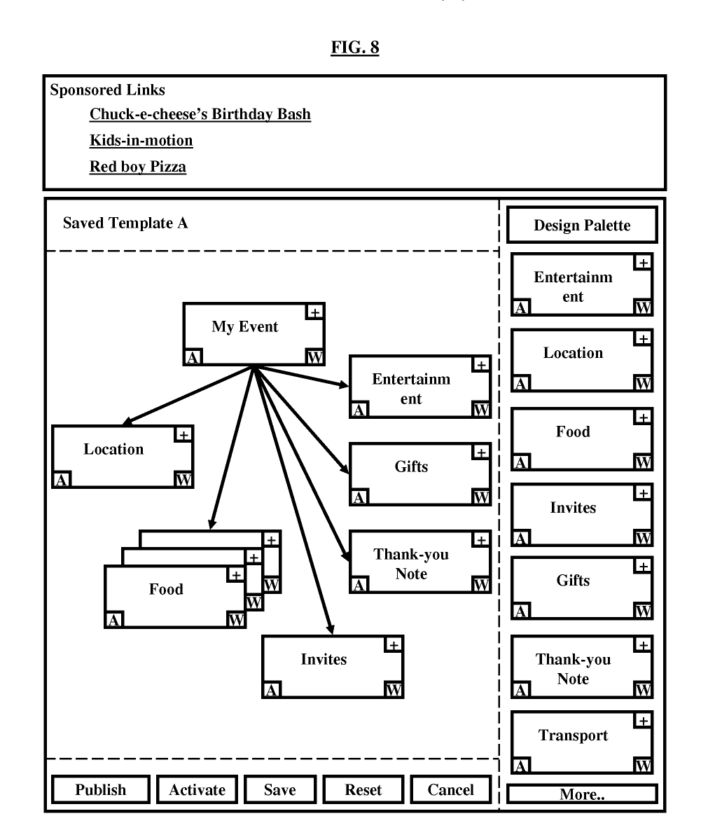

FIG. 8 is a snap shot indicating a sponsored template for EAM, according to embodiments as disclosed herein. The event plans created by users for different events may be saved and published if desired by the user. In addition, sponsoring companies, vendors or professional event organizers may also create and publish templates to attract users to use their offerings. The user can access the sponsored templates by clicking on the links provided at the top of the template in the sponsored links column. The link will direct the user to the list of templates of the selected sponsor.

For example, by clicking on the sponsored link kids-in-motion, the user may be provided access to the templates provided by kids-in-motion. The sponsored templates behave the same as user-generated templates. The sponsored templates will be displayed in a separate ‘Sponsored links’ box in an attractive location on the page to promote them to the users. In an embodiment, a fee will be charged to the sponsors as part of the business model.

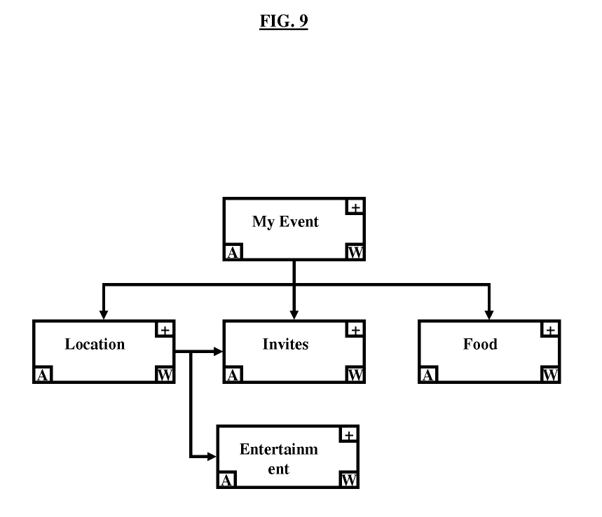

FIG. 9 illustrates sequencing of EAMs, according to embodiments as disclosed herein. The EAMs for an event may be sequenced one after the other in an order as defined by the user. In such cases, one or more EAMs can start only after the completion of another EAM. In the example, sending invites can occur only after an event location has been established. Consequently, the system will provide for sequencing EAMs. The direction of the ending arrow will show what follows what; completion of one EAM could lead to start of multiple EAMs. As depicted, the completion of location EAM may lead to start of invites and entertainment EAMs. Completion of multiple EAMs could lead to the start of one or multiple EAMs. When a dependency is established, start date of the following EAM will be automatically set to the end date of the prior EAM. The system will also allow for manual input of start dates either by actual date or by time period (such as 2 weeks later).

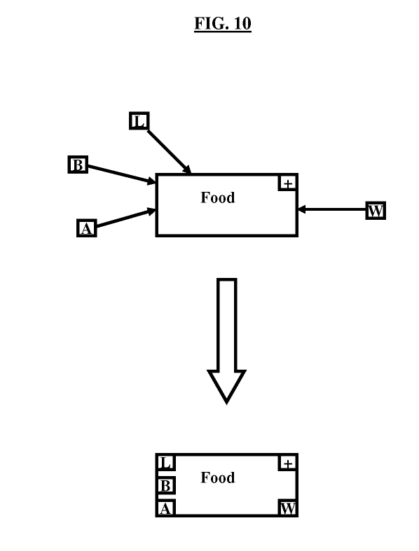

FIG. 10 indicates configuration of sub objects with EAM, according to embodiments as disclosed herein. Different use cases may have requirements for slightly different configurations of attributes/sub-objects depending on the type of event planned. In order to provide users full flexibility, and also to make the solution configurable vs. rigid, a flexible configuration feature will be provided. Users who want to modify EAMs can add or exclude attributes/sub-objects. An admin environment will be provided to customize EAMs. Users can add or delete sub-objects associated with an EAM from an available list of sub-objects. Some of the sub objects that may be added are 1. Activities (A), 2. Budget (B), 3. List (L), 4. Google Wave (W), 5. Map (M), 6. Attachments (H) and 7. Team (T). Once the associations are made, the sub-objects are ‘bound’ to the parent object. In the example, the sub objects L, B and A are bound to the parent object i.e., food.

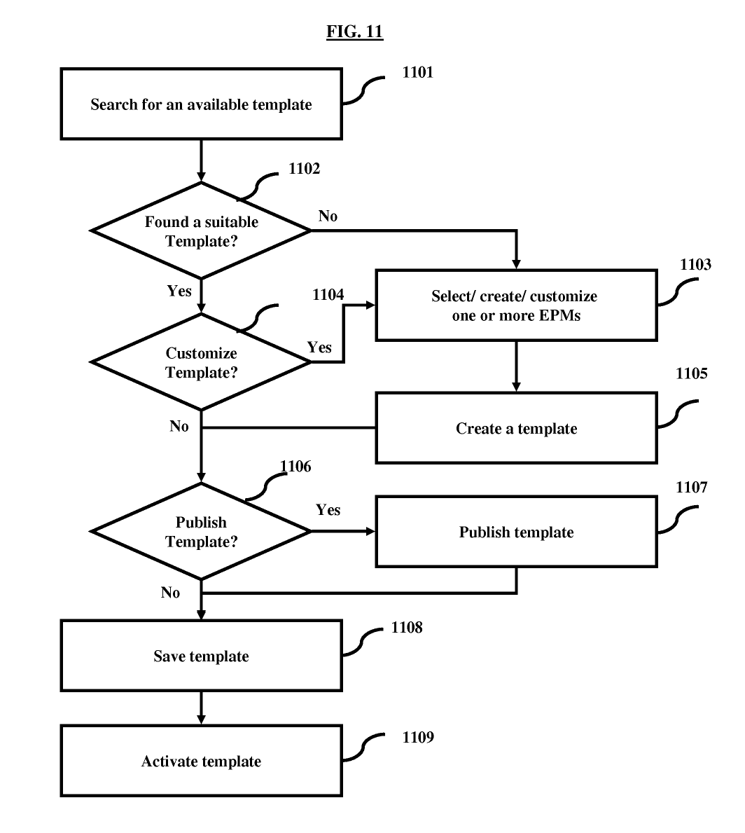

FIG. 11 is a flow chart illustrating template creation for an event, according to embodiments as disclosed herein. A user who in interested in creating an event plan may log in to the web site for the service. The user searches (1101) the templates available in the event planner as to if any of the template satisfy his requirements. The user may browse through the designs stored in the event database by providing the details of the event desired by him. A check is made (1102) if a template is suitable. If the templates available are not suitable, the user may be provided (1103) with options in order to create new templates, or select a template from the available templates and further customize the template in order to suite his requirements. Further, the template may be created (1105) as specified. On the other hand, if a template is available that may suite the users requirements, a check may be made. The user may be asked (1104) if he would like to customize the template. If the user prefers to customize the template the process moves to step 1103. In case the user does not wish to customize the template, he may be provided (1106) with an option if he would like to publish the template. If the user wishes to publish the template, the template may be published (1107). If the user doesn't wish to publish the template, the template may be saved (1108). In an embodiment, user may tag the template so that it can be easily searched. Public templates are available for anyone to reuse. Private are for the user only. Any confidential info such as user names, costs, etc. may be deleted before publishing the templates. Templates can also be created and offered by sponsors. For e.g., a sponsor like Chucky Cheeses can create a birthday party template and publicize it to the community. Further, the saved template may be activated (1109) for use by the user to plan his event. The various actions in method 1100 may be performed in the order presented, in a different order or simultaneously. Further, in some embodiments, some actions listed in FIG. 11 may be omitted.

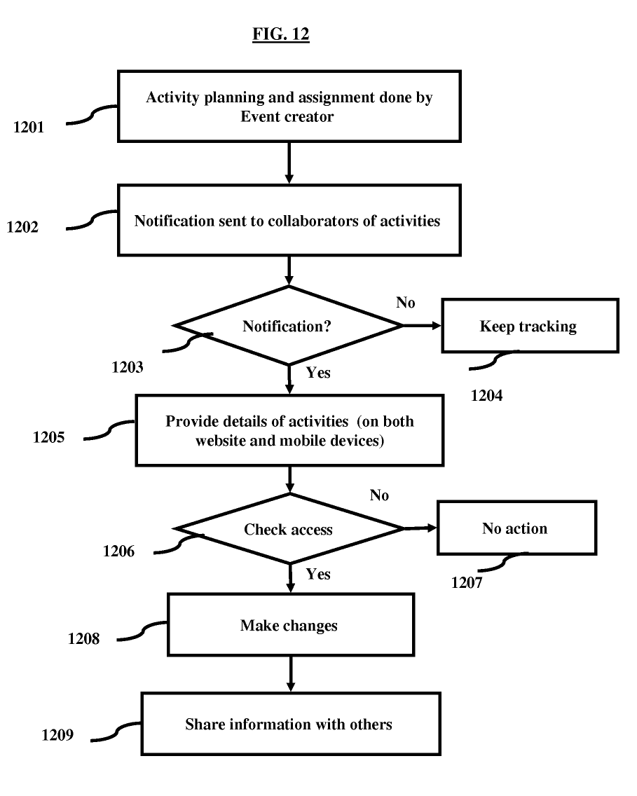

FIG. 12 is a flow chart illustrating mobile collaboration, according to embodiments as disclosed herein. A user who wants to plan an event may access the event planner service. The event creator may create (1201) a template for the event planner and he may also assign the activities of the event to different collaborators. In an example, if the event is a party the user may assign different activities such as food, entertainment, location and so on to different collaborators. Once the activities are assigned and the template is activated, the event planner may send (1202) a notification to the collaborators for their respective activities. The event planner may have stored contact details of collaborators initially. The collaborators may receive notifications about activities assigned to them by email, SMS, etc. Collaborators can access their Smartphone goombal app and update the status of the activities (completion status, costs, notes, etc). Further, the application on the mobile device of the collaborators keeps checking (1203) for updates on notification. If there are no notifications, then the application may simply continue tracking (1204). If any notification is received, the collaborator may be provided (1205) details of the event and the activity that is assigned to him by the event creator on the specified web site and to his mobile device. For example, in case of party event, a collaborator A may be assigned the activity A i.e., to check for location. The notification may inform the collaborator A that he is responsible for location arrangement in the form of a SMS to his mobile device or he may be sent a mail or informed on the web site. In addition, information such start date, end date, owner of the event, other activities, collaborators, updates and the like may also be provided to the collaborators. In an embodiment, if collaborator A wishes to make a change in the activity update a check (1206) may be made if there is access to the field for collaborator A. In case, collaborator A does not have access to modify the field, no action is taken (1207). If the collaborator A has access to modify the field, the field may be modified (1208). In addition, collaborators may also create new activities through the mobile phone if needed. Further, the modifications may be shared with other collaborators too by sending (1209) an indication to them in the form of an SMS or an email. In an embodiment, collaborators can also share information with the broader event planning team through their mobile phones. For e.g., they can take a picture and send it for a vote to the collaboration team. They can select which group they want to send the picture to which may be the entire team or a subset. The various actions in method 1200 may be performed in the order presented, in a different order or simultaneously. Further, in some embodiments, some actions listed in FIG. 12 may be omitted.

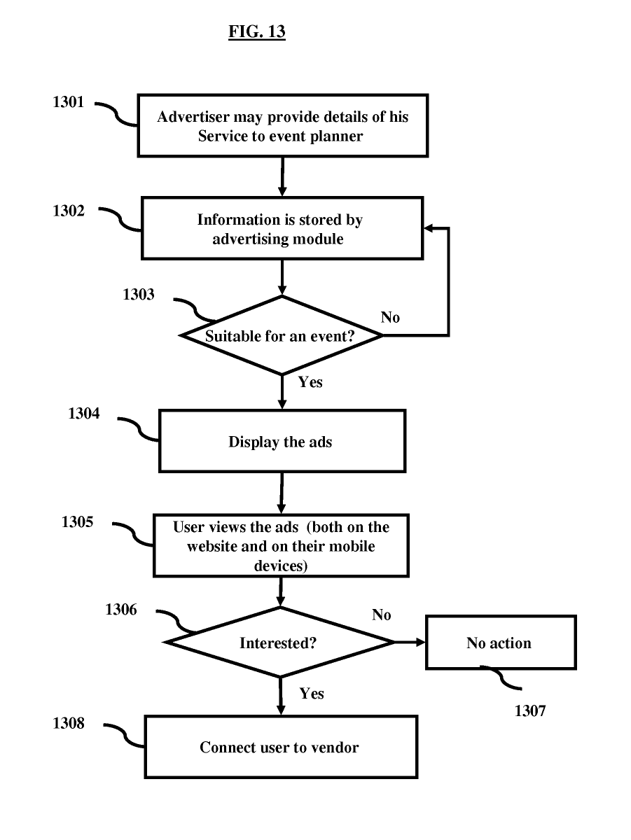

FIG. 13 is a flow chart depicting contextual placement of ads, according to embodiments as disclosed herein. An advertiser or a sponsor who may be interested in advertising the services offered by him may provide (1301) his details to the event planner. The details provided by him regarding his services may be stored (1302) in the advertising module 204 of the event planner. The advertising module 204 may check (1303) where the advertisement is suitable to be displayed. If the advertisement is suitable, the ad may be linked to the suitable event to display (1304) when the event is accessed. If the ad is not suitable, the ad may be just stored and referred when required. When a user accesses the event that is linked to the ad, the ad may be displayed to the user. The user may view (1305) the ad on his mobile device as well as on the specified web site. Further, a check may be made (1306) if the user is interested in the ad and the sponsor. If the user is not interested, then no action may be performed (1307). On the other hand, if the user is interested in the ad, he may click on the link provided by the sponsor. The user may be then connected (1308) to the sponsor. In an embodiment, the event plan may have specific details about type of event, activities, location and date. This information may be employed by advertisers so that they can make tailored offers (such as 20% discount on cake) to the specific event instance. Event planner can accept these offers and transact with the vendor directly through the site or print out the coupon and take it to the store. The various actions in method 1300 may be performed in the order presented, in a different order or simultaneously. Further, in some embodiments, some actions listed in FIG. 13 may be omitted.

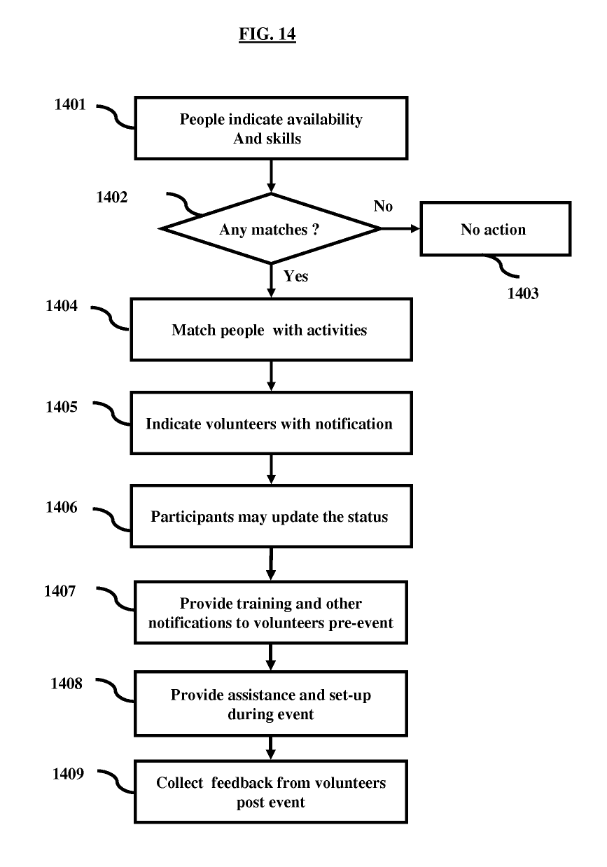

FIG. 14 is a flow chart depicting the process of tracking and managing events, according to embodiments as disclosed herein. To schedule people/volunteers to staff various event activities (such as manning a booth), it is important to capture people's availability and skill/interest information. People who are interested may visit the web site and provide (1401) details regarding their availability, skills and interest. Further, a check (1402) is made if there are any matches available to the interest of the users with the activities available. If there are no matches available, no action may be taken (1403). On the other hand, if there are any matches the event planner matches (1404) people with the available activities. Further, a notification may be sent (1405) to the volunteers. The volunteers would get a notification about their assignment along with any instructions/directions. In addition, participants could (1406) also have a list of activities/to-dos and can use the solution to update this status. The volunteers may be provided (1407) training and other notifications prior to the event in order to ensure that the activities are in progress. Further, the volunteers may be provided (1408) required assistance and set up for the events. Once the activities are carried out, the volunteers may be asked (1409) to provide their feedback and comments. The various actions in method 1400 may be performed in the order presented, in a different order or simultaneously. Further, in some embodiments, some actions listed in FIG. 14 may be omitted.

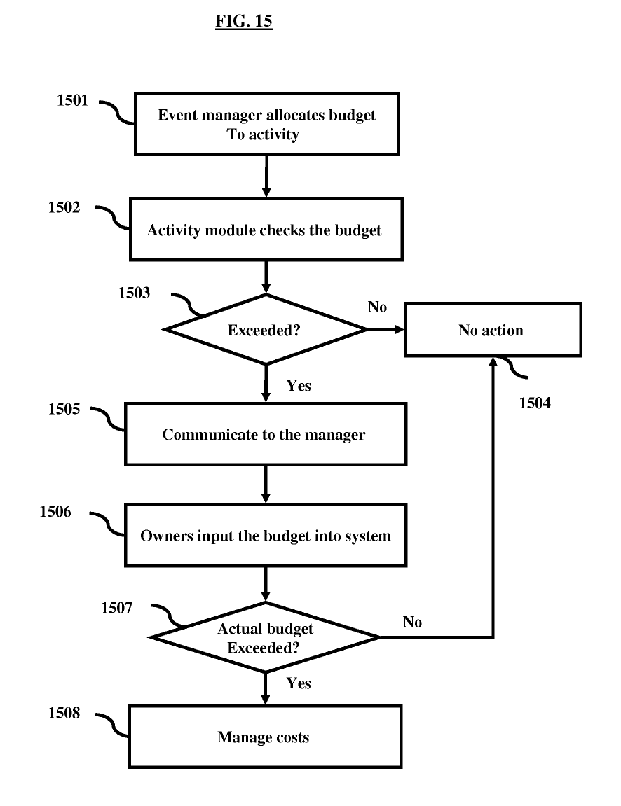

FIG. 15 is a flow chart depicting the process of budget and cost tracking, according to embodiments as disclosed herein. The event manger who is responsible for organizing the events allocates (1501) budget to the activities involved in the events. The activity module owner receives the notification of the activity and may make a check (1502) for the budget. Check is made (1503) if the budget has exceeded the amount allocated for that particular activity. If the amount has not exceeded, then no action may be taken (1504). If the budget has exceeded the amount allocated for the activity, the activity owner may communicate (1505) the same to the event manager. Further, the activity manager may also ask for approval. As costs are incurred, the activity module owners can input (1506) these into the system. The system tracks actual vs. cost and alerts if the actual exceed available budget amount. A check is made (1507) if the actual amount has exceeded the amount allocated for the budget. If the budget has not exceeded the amount allocated then the process moves to step 1505. If the allocated budget is exceeded, then intimation may be sent to the event manager to manage the costs. In an embodiment, the event manager may reallocate the budget based on the importance of the events and their costs. The various actions in method 1500 may be performed in the order presented, in a different order or simultaneously. Further, in some embodiments, some actions listed in FIG. 15 may be omitted.

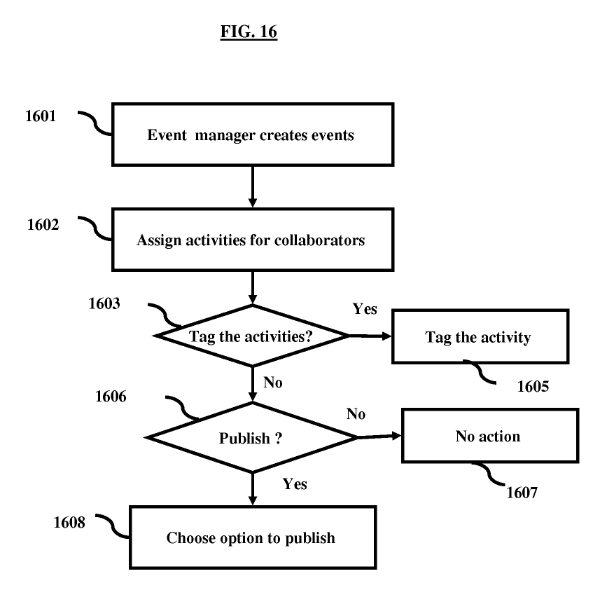

FIG. 16 is a flow chart depicting the process of managing calendar events and scheduling, according to embodiments as disclosed herein. An event manager may create (1601) an event such as a party. Further, the event manager may access a calendar provided in the event planner in order to schedule the event and assign (1602) the activities of the event to different collaborators. In an example, activities such as food, entertainment, location and so on may be assigned to different collaborators. In an embodiment, the calendar may be organized in the form of a table that provides details of different activities to the event manager and collaborators. The assigned activities may be shown in the form of the summary to people who access the calendar. Drill down will show details of activities and particularly only those activities with start dates may be shown. A color code will be used to show completed, pending and delayed EAMs and activities. Daily, Weekly and Monthly views will be offered. The event planner may then send intimation to all the collaborators who have been assigned activities by the event manager. The intimation may be in the form of a notification through an email, SMS or the like. The calendar may provide an option to the event manager to tag the activities so that the activities may be easily searched. The event manager may be asked (1603) if he wishes to tag the activities. In case, he agrees to tag the activity, the activity may be tagged by the tag line provided by the event manager. Tagging of activities may have restricted access, as collaborators may not be allowed to tag the activities. Further, the event manager may be asked (1605) if he wishes to publish the calendar. If the event manager doesn't want to publish the event, no action may be performed (1607). On the other hand, if the event manager wishes to publish the calendar, the calendar may be published (1608). During publishing different options may be offered to the event manager as to publish as either public or private. If the calendar is published as private, only the members of the event planning team may have access to the calendar. In case if it is published as public everyone may have access to search for the calendar and view the calendar. The various actions in method 1600 may be performed in the order presented, in a different order or simultaneously. Further, in some embodiments, some actions listed in FIG. 16 may be omitted.

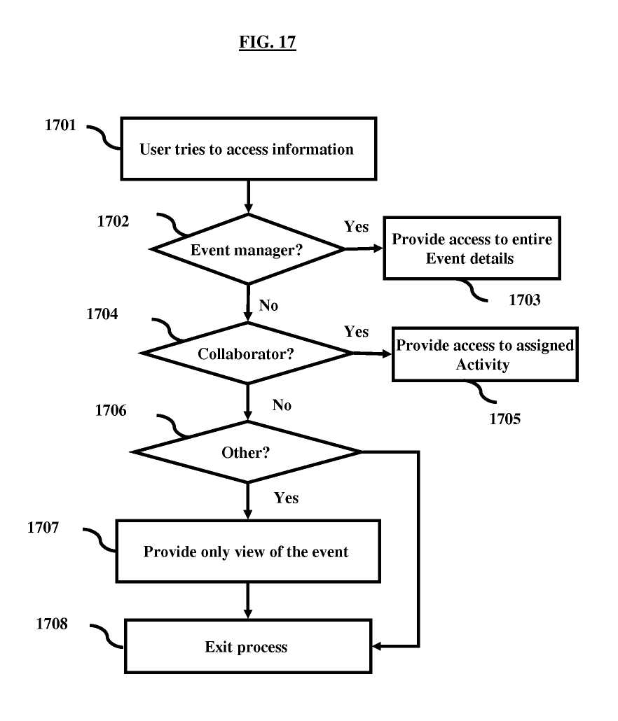

FIG. 17 is a flow chart depicting a process for controlling access for user, according to embodiments as disclosed herein. A user may try to access (1701) information on the event planned such as calendar, event tracking scheduler and the like. The method makes a check (1702) if the user is the manager of the event. If the user is the event manager, then the method provides access (1703) to read or write the entire details stored regarding the event as the event manager is the one who creates the event. In case the user is not the event manager, a check is made (1704) if he is a collaborator. In case the user is a collaborator, he may be provided (1705) access to read and write or modify only the activities that may be assigned to him. If the user is not a collaborator, a check is made (1706) if he is any other user who is normally accessing the information on the event. In case the user is not associated with the event, he may be provided (1707) access to only view the event details. The access to view may be provided only if the event is stored as a template. The process then exists (1708). The various actions in method 1700 may be performed in the order presented, in a different order or simultaneously. Further, in some embodiments, some actions listed in FIG. 17 may be omitted.

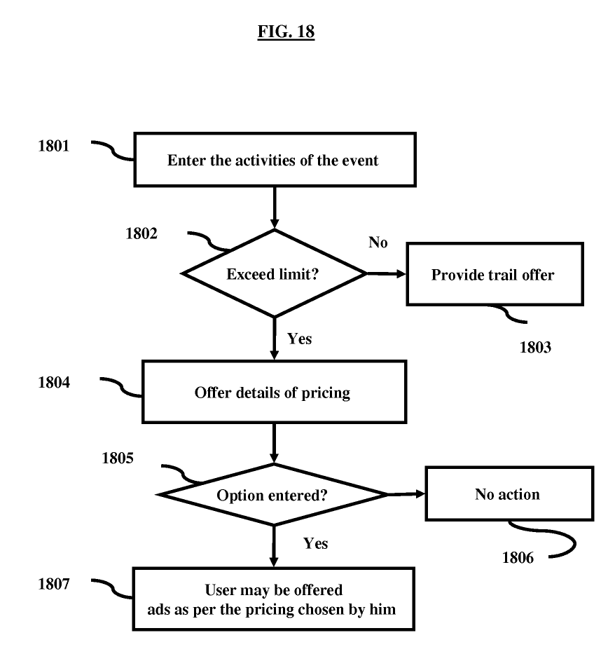

FIG. 18 is a flow chart depicting the process of monetization, according to embodiments as disclosed herein. When a user is planning his event, he may be offered different ads that relate to his event. The user may enter (1801) the details of his event such as the activities of his event. The event module 204 may be configured to offer the list of ads to the user and the pricing related to the same. When the user enters the list of activities for his event, the event module 204 checks (1802) for the number of activities in his event list. The event module 204 maps the ads to the list of activities and determines if the list is within the trial offer. In case if activity list limit is not exceeded, the package may be offered (1803) on trial basis to the user to test for the offered ads. In cases such as events with ten EAMs or less would be free of charge. On the other hand, if the limit to be offered for trial is exceeded, then the event module 204 may offer (1804) the available ad packages to the user along with the details of pricing. In an embodiment, a tiered fee structure based on the number of activities offered may be provided. For example, tiered pricing will be offered for 11-25 EAMs, 26-50 EAMs, and so on. Pricing will be per event. An annual subscription pricing will also be offered for users who have more frequent use of the solution. For example, professional event planners may require very frequent access and also manage a lot of events as part of their job as such they would be offered larger discounts. Further, check is made (1805) if the user has chosen any pricing package offered. In case the user is not interested in choosing any options, no action is taken (1806). If the user chooses any package, the ad in the package may be offered (1807) to the user for the pricing chosen. In an embodiment, users can choose to not accept ads and pay a higher fee (also tiered based on number of activities planned). The various actions in method 1800 may be performed in the order presented, in a different order or simultaneously. Further, in some embodiments, some actions listed in FIG. 18 may be omitted.

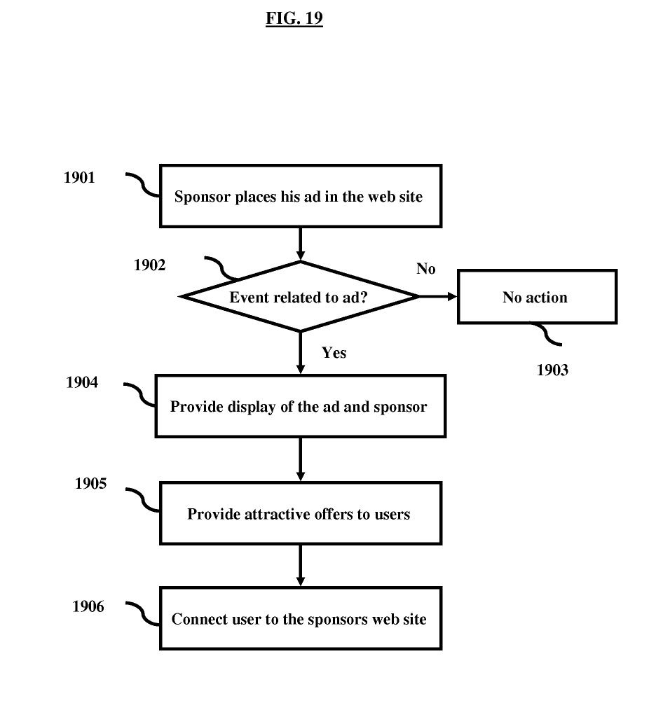

FIG. 19 is a flow chart depicting advertising revenue based monetization, according to embodiments as disclosed herein. The revenue based stream is to attract ad/sponsor revenues. Ad revenue is based on standard metrics like click-through rates. Sponsor revenue is based on placing appropriate promotions/offers in the context of an event. A sponsor who may be interested in advertising his ads or in sponsoring for activities related to some specific events may place (1901) ad in the event planner web site. Further, the ad may be stored in the advertising module 207. The advertising module 207 may continuously keep tracking (1902) if there are any events where the ad could be relative. If there is no event related to the ad no action may be taken (1903). If there is an event that the ad could be used to relate, then the advertisement may be displayed (1904) and also links related to that particular ad may also be displayed in the web page. In addition, in order to attract the users to the advertisement and the offers provided by the sponsor some additional discounts and incentives may be displayed (1905). If the user prefers to check out some of the offers provided by the sponsors, the user may be connected (1906) to the sponsors web site. The connection may be by just clicking on a link of the sponsor or the like. The various actions in method 1900 may be performed in the order presented, in a different order or simultaneously. Further, in some embodiments, some actions listed in FIG. 19 may be omitted.

In an embodiment, the method provides users to give reviews, recommendations and ratings for events to the broader benefit of all users. When an event planner creates and hosts an event, he can ask for feedback from the event participants. Event participants can then rate the events, provide reviews and offer recommendations. When the event planner publishes the event template, these user reviews, ratings and recommendations become available to the overall user community. Other site visitors and users can view these reviews, ratings and recommendations and benefit from others' experiences.

In an embodiment, logic may be built to provide email and SMS alerts for important milestones such as: confirmation of their responsibilities soon as a event plan is activated in which the user is an owner of some task such as an EAM or Activity. Forthcoming deadlines/due dates—a 24-hour notification will be given to any incomplete activity. Escalation wherein any activity is incomplete on the due date, an escalation will be sent to both the activity owner as well as the people higher up in the hierarchy (e.g. Event Planner).

In an embodiment, considering that in any collaborative event execution situation different collaborators will have unique responsibilities, it would be beneficial to give specific access rights to users to help them manage only their specific activities. The access will be READ and READ-WRITE. The event planner will have full access to the entire event plan at all times. Collaborators will have READ-WRITE access to EAMs and activities they own. Collaborators will have only READ access to everything else. Access control will be inherited in a hierarchical manner; users at the higher node will have full access to everything below their ‘node’.

In an embodiment, the method enables planning and execution of recurring events that occur on a regular basis—such as weekly, monthly, etc. A recurring flag may be used to indicate such an activity. By checking a ‘Recurring Event’ flag, the user can select the period of recurrence. The solution will automatically create a new instance of the event starting with the new period and adjust all timelines accordingly. For each of the new event instances, the solution will enable execution as described previously.

In an embodiment, a free 30-day trial period will be offered for new users. During the trial period, users will have access to complete functionality. After the trial period, charges will apply.

In an embodiment, various planning tools may be provided to the users. The planning tools may include check lists, budget estimator, invitation templates, polls, “What to bring” lists, music check lists, photo and video sharing, etc. to enhance value to users.

In an embodiment, the method also provides storage capacity to upload and share different kinds of content such as documents, presentations, videos, audio, invitee lists, etc. A fee may be charged for exceeding storage capacity. Different users will have access rights to storing, deleting, and updating stored content.

In an embodiment, the method also provides integrations to online gift card vendors so that event attendees can purchase gift cards online and gift them to the event host. In an embodiment, there may be integration to common mapping sites like Google maps, MapQuest, etc.

In an embodiment, the method may also provide a capability to capture user feedback for enhancements and new product features. An idea submission and categorization capability will be provided for users to submit their ideas. A summarized report and filtering capability will be provided to help capture aggregate information. Functionality will be provided to seek votes from users to prioritize designed features.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

The embodiment disclosed herein specifies a system for collaborative event planning. The mechanism allows planning events collaboratively by providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The device may also include means which could be a combination of hardware and software means and at least one memory with software modules located therein. Thus, the means are at least one hardware means and/or at least one software means. The method embodiments described herein could be implemented in pure hardware or partly in hardware and partly in software. The device may also include only software means.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method of planning an event by an organizer on a event planning collaboration platform, said method comprising:
defining a template for said event;
activating said template for conducting said event;
assigning collaborators to specific activities of said template; and
tracking progress of said event through said collaboration platform.

2. The method as in claim 1, wherein defining a template comprises of searching available templates on said collaboration platform;
selecting a template, if a suitable template is found; and
creating a new template, if a suitable template is not found.

3. The method as in claim 1, said method further comprising publishing said template.

4. The method as in claim 3, wherein said publishing is private.

5. The method as in claim 4, said method further comprising blocking private information from being displayed in public templates.

6. The method as in claim 3, wherein said publishing is public.

7. The method as in claim 1, said method further comprising tagging said template to enhance the ability to search said template.

8. The method as in claim 1, said method further comprising said collaborators updating status of activities they are responsible for through said collaboration platform.

9. The method as in claim 1, said method further comprising said organizer assigning specific rights to collaborators for editing and viewing activities, wherein rights provided to a collaborator on a parent node in said event is applicable to all child nodes of said parent node even when there are no specific rights assigned to said child nodes of said parent node.

10. The method as in claim 9, said method further comprising a collaborator from said collaborators creating a new activity, wherein said collaborator has the right to create said activity.

11. The method as in claim 1, wherein a collaborator is one among event participant, event organizing member, vendor and volunteer.

12. The method as in claim 1, said method further comprising choosing specific modes of communication between said organizer and said collaborators, wherein said specific modes include one or more of SMS, email, chat, and message boards.

13. The method as in claim 1, said method further comprising configuring alerts for specific milestones in said event, wherein milestones comprise of starting of said event, completion of an activity in said event, commencement of an activity in said event, completion of said event, creation of a new activity, updation of an existing activity, deletion of an activity.

14. The method as in claim 1, said method further comprising publishing volunteer request on said collaboration platform to staff said event;
prospective volunteers publishing their interest in taking up volunteer activities on
said collaboration platform; and
said platform matching requests and interests.

15. The method as in claim 14, wherein said matching of requests and interests for volunteering is based on at least one among skill, interest and availability.

16. The method as in claim 14, said method further comprising organizer of said event seeking feedback from one or more volunteers through said collaboration platform after completion of said event.

17. The method as in claim 1, said method further comprising
organizer choosing to receive feedback from participants of said event;
said collaboration platform seeking feedback information from participants of said event; and
said collaboration platform sending reports on feedback information collected to said organizer.

18. The method as in claim 17, wherein said feedback is one of review comment, rating, and recommendation, picture, audio, video, blog, and tweet.

19. The method as in claim 1, wherein said template is a recurring template, wherein said event is an recurring event at regular intervals.

20. The method as in claim 1, said method further comprising
one or more advertisers choosing to sponsor one or more activities of said event based on pre-defined parameters;
organizer choosing a sponsor from among the sponsor opportunities from said one or more advertisers with matching criteria for sponsoring event; and
said collaboration platform placing sponsor ad from said advertiser on the page of said event for one or more activities.

21. Method of promoting services by a vendor on a collaboration platform, said method comprising:
creating a template for an event associated with said services; and
publishing said template for use by a community on said collaboration platform,
wherein said vendor is the organizer of said event.

22. Method of advertising in an event by an advertiser on a collaboration platform, said method comprising:
said advertiser choosing to publish one or more advertisements and/or promotional offers on said collaboration platform based on pre-defined parameters; and
said collaboration platform displaying said ads to users based on said pre-defined parameters.

23. The method as in claim 22, wherein said pre-defined parameters comprise of:
type of event,
type of service,
location, and
date.

24. A computerized system for planning an event by an organizer on a event planning collaboration platform, said system comprising at least one means for:
defining a template for said event;
activating said template for conducting said event;
assigning collaborators to specific activities of said template; and
tracking progress of said event through said collaboration platform.
